(19) United States
(12) Patent Application Publication
(10) Pub. No.: US 2007/0025010 A1
(43) Pub. Date: Feb. 1, 2007

(54) Method of and apparatus for forming servo bursts on a magnetic storage disk

(75) Inventor: Michael Alan Miles, Hayling Island (GB)

Correspondence Address: PILLSBURY WINTHROP SHAW PITTMAN, LLP, P.O. BOX 10500, MCLEAN, VA, 22102, US

(73) Assignee: XYRATEX TECHNOLOGY LIMITED, Havant (GB)

(21) Appl. No.: 11/486,167

(22) Filed: Jul. 14, 2006

Related U.S. Application Data
(60) Provisional application No. 60/702,997, filed on Jul. 28, 2005.

(51) Int. Cl. G11B 21/02

(52) U.S. Cl. 360/75

(57) ABSTRACT

A method of and apparatus for forming servo bursts on a magnetic storage disk are disclosed. The method comprises forming at least one phase-encoded servo burst to a surface of the disk using a printing-process step that writes all parts of the phase-encoded servo burst substantially simultaneously. The phase encoded by the at least one phase-encoded servo burst varies continuously with radial position.

This application claims the benefit of priority to U.S. application Ser. No. 60/702,997, filed Jul. 28, 2005, the content of which is hereby incorporated by reference.

The present invention relates to a method of and apparatus for forming servo bursts on a magnetic storage disk.

More generally, the present invention relates to apparatus and methods for forming phase modulated servo bursts on the surface of a magnetic disk of a hard disk drive (also known as a head disk assembly or HDA).

When a hard disk is manufactured, so-called servo tracks are written permanently to the disk. These servo tracks are in the form of bursts of data written at intervals circumferentially and radially across the whole of the data area of the disk. The servo tracks are used by the hard disk's read/write head (known as the product head) during normal use of the disk in order to allow the head to know its position over the disk.

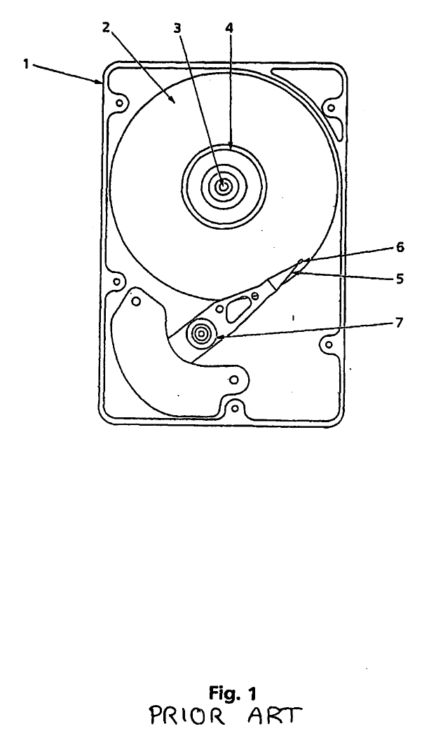

Traditionally, servo tracks have been written in the following way during manufacture. Referring to FIG. 1, the head disk assembly 1, which comprises the hard disk 2, the product read/write head 6, motor 4, etc., is inserted into a servo track writer. The servo track writer has its own so-called clock head which is inserted into the head disk assembly 1 to write a so-called clock track. This clock track is subsequently read back by the clock head to allow the angular position of the disk 2 relative to the servo track writer to be known accurately at all times, so that the product head 6 can write servo data at the desired locations.

So-called media writers operate similarly, by writing servo tracks simultaneously to plural disks.

As an alternative, so-called self-servo writing systems are currently being developed. These avoid the need of a separate clock head, and instead use the product head 6 to write its own clock data, interleaved with servo data, to create its own reference points as it writes the servo tracks across the disk.

A significant issue using any of these and similar servo writing processes is to ensure that the phase of the servo tracks is aligned with the phase of the clock tracks on the disk and hence with each other. This is technically very difficult, principally because of the very small physical size of the bursts of data written to the disk and also because the bursts of data consist of very high frequency signals.

A typical layout of information on the surface of a disk 2 divides the surface into data sectors and servo sectors. The servo sectors are arc-shaped or spoke-like regions that extend across the disk surface from the inner diameter to the outer diameter. The servo sectors contain servo information to allow the product head 6 to identify a track when operating in seek mode, and to stay centred on a track when operating in track following mode. Typically the servo information includes (i) an unique Gray Code to allow one or two individual tracks to be uniquely identified on the disk; and (ii) servo bursts from which can be derived a “position error signal” (PES) to aid in aligning the product head 6 with the centre of the track.

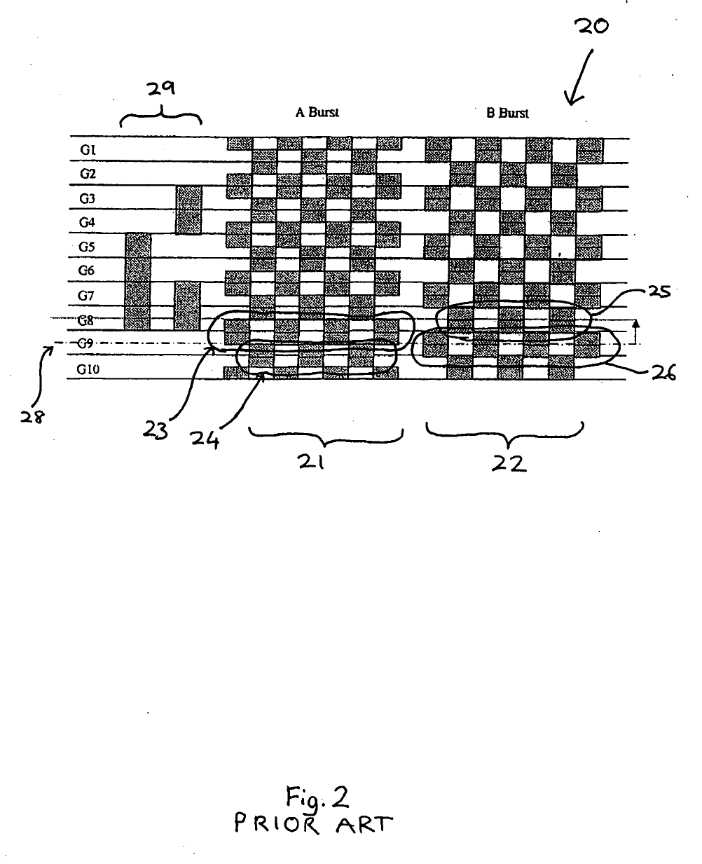

The most common form of servo burst is amplitude demodulated servo bursts, as shown in FIG. 2. In this example, the servo pattern is a quadrature amplitude burst servo pattern 20 arranged into an A burst 21 and a B burst 22. The quadrature amplitude burst servo pattern 20 uses four servo burst sub-fields 23,24,25,26 written at half track intervals. The relative amplitude of each of these four sub-fields 23,24,25,26, as detected by the product head 6 as it travels on a circumferentially path over the sub-fields 23,24,25,26, allows the radial position of the product head 6 with respect to a track centre line 28 to be uniquely determined, and its position adjusted accordingly.

The amplitude burst servo pattern 20 can discriminate only within cylinder blocks containing four half tracks (corresponding to the four sub-fields). Typically then a Gray Code field 29 is also provided, positioned radially adjacent to the servo bursts 21,22, to uniquely identify each cylinder block of four half tracks.

A disadvantage of the amplitude modulated servo burst technique is that because in practice the product head 6 is more narrow than the track width (the head width being typically around 70% of the track width), the PES will not be perfectly linear. Another disadvantage is that because the amplitude modulated servo burst cannot discriminate beyond one or two tracks, the Gray Code 29 must be relatively long to allow unique identification of each track. The Gray Codes 29 therefore take up a lot of space on the disk 2, which is therefore not available for storing user data, and also require greater data processing.

Other variations of the amplitude modulated servo burst scheme are known, but suffer from similar problems. Nevertheless, nearly all disk drive assemblies in production today use amplitude modulated servo bursts.

It has been suggested to use a phase-encoded servo pattern together with a phase demodulation scheme. Examples of phase-encoded servo patterns are disclosed in US-B-4549232 and EP-A-0578598 (both owned by IBM Corporation).

An idealised phase-encoded servo pattern is shown in FIG. 1 of US-B-4549232. The servo pattern comprises two circumferentially adjacent fields having a single-frequency sine wave servo burst signal. The phase of each sine wave servo burst signal varies with radial displacement on the disk. The phase of the first field is opposite to that of the second field. The phase demodulator measures the difference in phase between the first field and the second field. This phase difference is used to give a measure of radial position of the product head.

However, as admitted by US-B-4549232, there is currently no practical way of realising the idealised phase-modulated servo burst due to problems associated with writing the pattern using known techniques. The solution to this as proposed in US-B-4549232 is to use a modified phase-modulated servo burst as a practical solution to this problem. As can be seen from FIG. 4 of US-B-4549232, the modified servo burst is implemented by using the product head to write a phase modulated servo track every half track, leading to a “stepped” approximation of the idealised phase modulated servo pattern. However, the stepped version does not have the same linearity of PES as the idealised version. Also problems exist in achieving the necessary coherency of servo bursts as the servo tracks are written on a track-by-track basis. These problems have led the industry generally not to use phase modulated servo bursts on hard disks, despite the potential advantages that they offer.

According to a first aspect of the present invention, there is provided a method of forming servo bursts on a magnetic storage disk, the method comprising: forming at least one phase-encoded servo burst on a surface of the disk using a printing-process step that writes all parts of the phase-encoded servo burst substantially simultaneously, wherein the phase encoded by the at least one phase-encoded servo burst varies continuously with radial position.

Preferably, all of the servo bursts on the disk are written in one or more printing process steps. Most preferably all of the servo bursts on the disk are written in a single printing process step.

According to a second aspect of the present invention, there is provided an apparatus for forming a servo burst on a magnetic storage disk, the apparatus comprising: a printing device constructed and arranged to form at least one phase-encoded servo burst on a surface of the disk using a printing-process that substantially writes all parts of the phase-encoded servo burst simultaneously and such that the phase of the at least one phase-encoded servo burst varies continuously with radial position relative to the disk.

The printing process may comprise using a “stamper” in performing thermal imprint lithography on the substrate of the disk to form the desired pattern of the servo burst. Such a thermal imprint technique is described for example in US-B-6869557 and US-B-6814898. Alternatively, the pattern may be formed on the disk using magnetic lithography using a flexible magnetic mask, as described for example in “Magnetic Lithography Using Flexible Magnetic Masks: Applications to Servowriting”; Zvonimir Z. Bandic, Hong Xu, Yimin Hsu, and Thomas R. Albrecht; IEEE Transactions On Magnetics. Vol. 39, No. 5; September 2003; pages 2231 to 2233.

By using a printing process that forms all parts of the phase-encoded servo burst substantially simultaneously, the problems inherent in the prior art servo-writing techniques using a servo-writing head of achieving coherence in servo-tracks on a track-by-track basis are obviated by the preferred embodiment of the present invention.

According to a third aspect of the present invention, there is provided a method of forming servo bursts on a magnetic storage disk, the method comprising: forming plural phase-encoded servo bursts on a surface of a magnetic storage disk such that the phase of each phase-encoded servo burst varies continuously with radial position relative to the disk; and, subsequently defining the number of tracks per unit radial distance on the disk surface.

The prior art arrangement of servo-track writing every half track is highly dependent upon the width of the product head. It would be useful to industry to have a way of forming servo tracks on a disk that is independent of the product head width. Disks formed in this manner could then be used with a variety of different product heads to achieve different numbers of tracks per unit radial distance (commonly measured as tracks per inch or TPI). The preferred embodiment of the present invention allows a servo pattern to be formed on the disk practically independently of the width of the product head. This allows the TPI to be determined after the servo pattern has been written to the disk. In one embodiment, regions having different TPI are defined on the same disk. In another embodiment, disks having different TPI may be formed using the same servo pattern. This may be advantageous, for example, when a new product head becomes available, having for example a smaller head width. The same servo track writer can then be used without modification to accommodate the change in product head as the same servo track writer can be used to write the servo pattern to a hard disk generally with little regard to the precise TPI, and then the TPI selected after the servo pattern has been written taking into account inter alia the width of the product head.

In an embodiment, the phase of each phase-encoded servo burst varies linearly with radial position. The defining may define the number of tracks per unit radial distance on the disk surface by defining the centre of each track to be located at uniform phase intervals.

In an embodiment, the number of tracks per unit radial distance is defined taking into account the width of the read/write head to be used with the disk.

Embodiments of the present invention will now be described by way of example with reference to the accompanying drawings, in which:

FIG. 1 is a schematic plan view of a prior art head disk assembly;

FIG. 2 is a representation of a conventional prior art amplitude modulated servo burst; and,

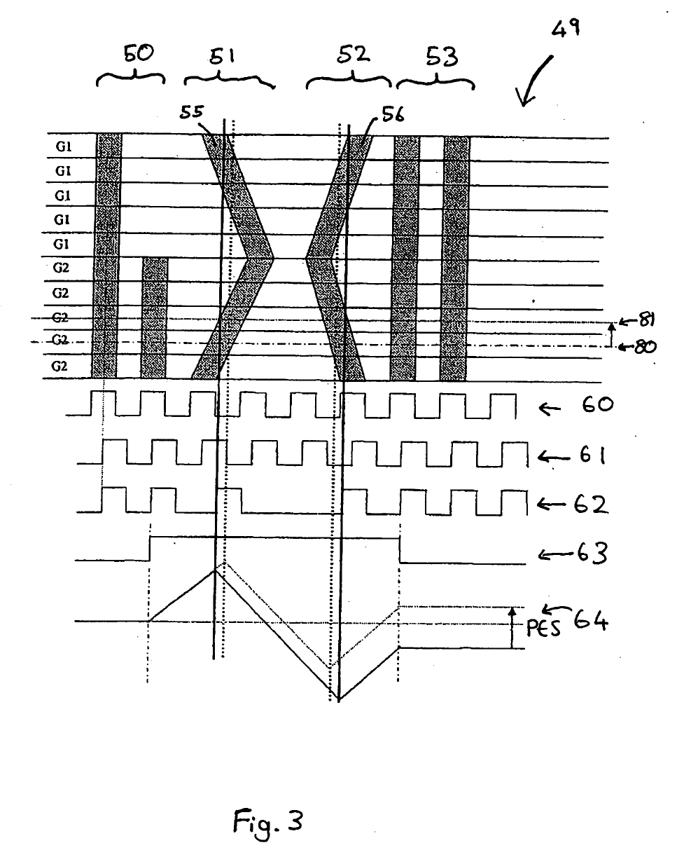

FIG. 3 is a representation of an example of a phase modulated servo burst according to an embodiment of the present invention.

Referring to FIG. 1, a head disk assembly 1 has a rotating magnetic disk 2 which is mounted on a spindle 3 of a disk drive motor 4 which rotates the disk 2. The head disk assembly 1 includes a so-called product arm 5 which carries a read/write head 6 which includes read and write elements for reading data from the disk 2 and writing data to the disk 2 in normal use of the head disk assembly 1. Such data will normally be user data. The arm 5 can be pivotally moved over the surface of the disk 2 by an actuator 7.

FIG. 3 shows a part of a phase modulated servo sector 49 in accordance with a preferred embodiment of the present invention. The servo sector 49 is shown spanning ten tracks, which are divided into two cylinder blocks G1, G2. The servo sector 49 comprises a Gray Code field 50, a first servo burst field 51, a second servo burst field 52, and a synchronisation field 53.

A first phase burst 55 and second phase burst 56 are shown in the first and second servo burst fields 51,52 respectively. Each phase burst 55,56 consists of a band of magnetic polarity which extends across each cylinder block at an angle. Due to this angle, the product head 6 will detect the band at a different circumferential position, and hence having a different phase, depending upon the radial position of the product head 6. In this way, the phase of each band varies continuously and linearly through 360° across the radial extent of its cylinder block. The phase of the second phase burst 56 is the reverse of the first phase burst 55.

As the product head 6 moves circumferentially across the servo sector 49 along a path 80 (left to right in the drawing), it detects the changes of polarity of the fields shown. A demodulator (not shown) recovers a clock signal 60 from the signals generated by the Gray Code field 50 and synchronisation field 53. This signal is then shifted in phase, so that the leading edges of the signal are timed to coincide with the middle of the bursts, to produce reference signal 61.

Signal 62 represents the peak-detected signal detected by the product head 6. A position error signal (PES) 64 is derived from signal 62 as follows. When signal 62 shows that the end of the Gray Code field 50 is reached, the PES 64 starts ramping up. The PES 64 continues to ramp up until the first servo burst 55 is detected, at which point it is made to ramp down. The PES 64 continues to ramp down until the second servo burst 56 is detected, at which point it is made to ramp up again. The PES 64 continues to ramp up until the start of the synchronisation field is detected.

In this way a single value for the PES 64 is obtained which varies proportionally to the phase difference between the first servo burst 51 and the second servo burst 52 at that radial position, and thereby gives a measure for the radial position of the product head 6 within the cylinder block G2. As shown by the dotted lines, if the product head 6 moves one track to a new path 81, a new value of PES 64 is obtained. As will thus be appreciated, the PES 64 varies linearly and continuously with radial position of the product head 6 within each cylinder block G1,G2.

In the preferred servo pattern, each servo burst field 51,52 would contain many phase bursts 55,56 to create a “chevron-type” pattern. This in effect creates a sinusoidal wave in each field having a particular phase. This allows the phase information recovered from each servo field 51,52 to be averaged across the field and thus to be more resilient to errors in detecting the servo pattern.

The phase demodulator system can potentially discriminate among many different phase differences between the two fields 51,52. Accordingly, the cylinder block modulus can be increased beyond the one or two tracks that is typically possible with an amplitude modulated phase burst. In the example of FIG. 4, five phase differences are discriminated, thereby defining five tracks. This means that the Gray Code 50 can encode cylinder blocks of five tracks G1,G2 rather than individual tracks. This reduces the number of bits needed in the Gray Code 50 and stored in the servo sector 49. This reduces servo overhead for the disk 2 and allows more user data to be stored. This also allows a more efficient data processing operation to be performed on the Gray Code 50.

A preferred method of forming the servo pattern on the disk in accordance with an embodiment of the present invention uses thermal imprint lithography. In this method, a mould (or stamper/imprinter) is made having a plurality of features corresponding to the desired servo pattern that is to be formed on the disk 2. The disk 2 to be patterned has a thin film layer, for example of thermoplastic, deposited on the relevant surface(s) of the disk 2. A compressive moulding step is performed wherein the mould is pressed into the thin film layer to form compressed regions in the thin film layer, which generally conform to the shape of the features of the mould. The disk 2 is next subjected to a process to remove the compressed portions of thin film to expose portions of the underlying substrate of the disk surface. This may be accomplished by use of reactive ion etching (RIE) or wet chemical etching. This technique creates an embossed servo pattern on the disk 2. The mould can be reused for imprinting multiple disks.

In another embodiment of the present invention, magnetic lithography using a flexible magnetic mask is used to form the servo patterns on the disk surface. A mask is made consisting of patterned soft magnetic material (such as FeNiCo or FeCo) deposited on a thin flexible substrate. The pattern of the soft magnetic material is the same as the servo pattern to be formed on the disk 2. The mask is positioned in close proximity above the surface of the disk and an external magnetic field is applied. The magnetic field generated by the soft magnetic material causes a reduction (or cancellation) of the external field in close proximity to the mask. This allows the external field to penetrate only through the openings in the magnetic mask and cause selective reverse magnetisation of the initially DC-erased disk 2 to form the servo pattern on the disk 2. The mask can be reused.

Forming the servo patterns with either of these techniques means that the servo patterns are written substantially simultaneously. The problem of writing phase coherent servo information on a track-by-track basis is overcome by these techniques.

In addition, because in the preferred embodiment the servo patterns are not written with the product head 6 of the head disk assembly 1, or indeed with any head at all, the servo pattern need not be dependent on the width of the product head 6. This in turn means that the servo pattern can be formed on the disk without the TPI of the tracks having been determined or defined on the disk.

Last, given that the Gray Code 50 can encode cylinder blocks of plural tracks, such as five tracks G1,G2 in the specific example above, rather than individual tracks as mentioned above, the thermal imprint lithography and magnetic lithography processes are enormously simplified because fewer features are required of the stamper or mask respectively. This makes the thermal imprint lithography and magnetic lithography processes far more attractive than they were previously in the case where individual features had to be formed for each Gray code.

The tracks are defined on the disk subsequent to the servo patterns being formed. Typically this is carried out in accordance with the width of the product head that is to be used with the disk. The tracks are defined such that the centre of each track is located at uniform phase intervals on the disk. The drive is configured to locate the track positions by recording these phase intervals. This may be done for example by configuring firmware in the head disk assembly. This whole process is facilitated in the case where the phase-encoded servo bursts vary linearly with radial position.

In this embodiment, if the width of the product head changes, for example if a new product head is developed, the same servo track writer can be used without modification to accommodate the change in product head as the same servo track writer can be used to write the same servo pattern to a hard disk generally with little regard to the precise TPI that is ultimately used.

Embodiments of the present invention have been described with particular reference to the example illustrated. However, it will be appreciated that variations and modifications may be made to the examples described within the scope of the present invention.

1. A method of forming servo bursts on a magnetic storage disk, the method comprising:
forming at least one phase-encoded servo burst to a surface of the disk using a printing-process step that writes all parts of the phase-encoded servo burst substantially simultaneously, wherein the phase encoded by the at least one phase-encoded servo burst varies continuously with radial position.

2. A method according to claim 1, wherein the phase of the at least one phase-encoded servo burst varies linearly with radial position.

3. A method according to claim 1, wherein the printing-process comprises writing a second phase-encoded servo burst corresponding to the at least one phase-encoded servo burst at a position circumferentially offset and substantially adjacent said at least one phase-encoded servo burst and having the opposite phase from said at least one phase-encoded servo burst.

4. A method according to claim 1, wherein at least one phase-encoded servo burst is arranged to span a plurality of tracks.

5. A method according to claim 1, wherein the at least one phase-encoded servo burst varies through 360° of phase between a first radius of the disk and a second radius of the disk.

6. A method according to claim 5, wherein a Gray code is formed on the disk for allowing the portion of the disk defined between said first and second positions to be uniquely identified.

7. A method according to claim 6, comprising forming a plurality of said phase-encoded servo bursts, contiguously radially offset from adjacent phase-encoded servo bursts.

8. A method according to claim 1, wherein the printing process comprises performing thermal imprint lithography using a stamper.

9. A method according to claim 1, wherein the printing process comprises performing magnetic lithography using a flexible magnetic mask.

10. An apparatus for forming a servo burst on a magnetic storage disk, the apparatus comprising:
a printing device constructed and arranged to form at least one phase-encoded servo burst on a surface of the disk using a printing-process that substantially writes all parts of the phase-encoded servo burst simultaneously and such that the phase of the at least one phase-encoded servo burst varies continuously with radial position relative to the disk.

11. A method of forming servo bursts on a magnetic storage disk, the method comprising:
forming plural phase-encoded servo bursts on a surface of a magnetic storage disk such that the phase of each phase-encoded servo burst varies continuously with radial position relative to the disk; and,
subsequently defining the number of tracks per unit radial distance on the disk surface.

12. A method according to claim 11, wherein the phase of each phase-encoded servo burst varies linearly with radial position.

13. A method according to claim 12, wherein the defining defines the number of tracks per unit radial distance on the disk surface by defining the centre of each track to be located at uniform phase intervals.

14. A method according to claim 11, wherein the number of tracks per unit radial distance is defined taking into account the width of the read/write head to be used with the disk.
